(19) United States
(12) Patent Application Publication
(10) Pub. No.: US 2023/0393904 A1
(43) Pub. Date: Dec. 7, 2023

(54) SUSTAINABILITY-AWARE DATA CENTER WORKLOAD MANAGEMENT

(71) Applicant: Microsoft Technology Licensing, LLC, Redmond, WA (US)

(72) Inventor: Abhijit JONNALAGADDA, Hyderabad (IN)

(73) Assignee: Microsoft Technology Licensing, LLC, Redmond, WA (US)

(21) Appl. No.: 17/805,255

(22) Filed: Jun. 3, 2022

(51) Int. Cl. G06F 9/50

(52) U.S. Cl. CPC G06F 9/5083

(57) ABSTRACT

Aspects of the present disclosure relate to sustainability-aware data center workload management. In examples, a data center with which to process a workload is determined from a set of candidate data centers. The set of candidate data centers may include data centers that are geographically dispersed to account for variability in the availability of renewable energy, among additional or alternative environmental considerations. For example, the set of candidate data centers may be generated such that at least one candidate data center is in a location that experiences sunlight at any given time. As a result, a preferred data center from the set of data centers may vary based on environmental conditions (e.g., a time of day, a current season, and/or a weather forecast), such that workload processing is managed using the set of candidate data centers to reduce the associated environmental impact accordingly.

### BACKGROUND

An environmental impact associated with a data center may vary over time (e.g., throughout the day, depending on the time of year, and/or as seasons change), such that the data center may have periods of operation that have a comparatively high environmental impact, even in instances where data center workloads are optimized or otherwise tuned to reduce associated resource consumption.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to sustainability-aware data center workload management. In examples, a data center with which to process a workload is determined from a set of candidate data centers. The set of candidate data centers may include data centers that are geographically dispersed to account for variability in the availability of renewable energy, among additional or alternative environmental considerations. For example, the set of candidate data centers may be generated such that at least one candidate data center is in a location that experiences sunlight at any given time. As a result, a preferred data center from the set of data centers may vary based on environmental conditions (e.g., a time of day, a current season, and/or a weather forecast), such that workload processing is managed using the set of candidate data centers to reduce the associated environmental impact accordingly.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for sustainability-aware data center workload management according to aspects described herein.

FIG. 2 illustrates an overview of an example method for managing workload processing for a set of candidate data centers according to aspects described herein.

FIG. 3 illustrates an overview of an example method for transitioning a workload from a first data center to a second data center.

FIG. 4 illustrates an overview of an example method for reconfiguring a load balancer to transition a workload from a first data center to a second data center.

FIG. 5 illustrates an overview of an example method for generating requests by a client device that is associated with a workload that has been transitioned to another data center according to aspects of the present disclosure.

FIG. 6 is a block diagram illustrating example physical components of a computing device with which aspects of the disclosure may be practiced.

FIGS. 7A and 7B are simplified block diagrams of a mobile computing device with which aspects of the present disclosure may be practiced.

FIG. 8 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a data center includes a variety of hardware resources, including, but not limited to, networking devices, storage devices, sever computing devices, and/or cooling infrastructure, among other examples. A data center may process a variety of workloads, including, but not limited to, search workloads (e.g., request processing and/or web crawling), content distribution workloads, and/or machine learning workloads. A workload processed by the data center may be provided by a third party, as may be the case in software as a service (SaaS), platform as a service (PaaS), and/or infrastructure as a service (IaaS) contexts.

However, processing performed by the data center may have an associated environmental impact, as may result from energy consumed by the data center when processing such workloads. Further, the data center may have a period of time in which its environmental impact is comparatively higher. For example, the mixture of energy that is available to the data center may fluctuate over time, such that processing performed at a first time uses a higher proportion of renewable energy (e.g., wind or solar) as compared to processing at a second time.

Accordingly, aspects of the present disclosure relate to sustainability-aware data center workload management. In examples, a set of candidate data centers may be generated based on the geographic location of each data center so as to offset or otherwise account for variability associated with the availability of renewable energy at each location. A data center for processing a workload may thus be dynamically determined from the set of candidate data centers based on associated characteristics of the data center (e.g., the estimated or actual availability of energy from one or more renewable energy sources), thereby increasing the likelihood that the mixture of energy used to process the workload will have a reduced environmental impact as compared to processing by another data center having reduced availability of renewable energy.

For example, the set of candidate data centers may include a first data center at a first location and a second data center near a second location that is 160° to 200° degrees (e.g., 180°±20°) different in longitude as compared to the first location, such that the first data center and the second data are located at substantially opposing locations of the planet. Additionally, or alternatively, the set of candidate data centers may include a third data center near a third location that is 80° to 100° (e.g., 90°±10°) different in latitude as compared to the first location, such that the third data center is located in a different hemisphere than the first data center. Thus, as a result of associating data centers that are geographically dispersed, a preferred data center may change depending the availability of renewable energy at a given data center.

Using solar energy as an example, the set of data centers may be generated such that at least one candidate data center of the set of data centers is in a location (and/or uses electricity from a location) that experiences sunlight at any given time. Similarly, locations in different hemispheres may be used to account for seasonal differences in which the amount of sun exposure for a location changes throughout the year (e.g., shorter days in the northern hemisphere may be offset by longer days in the southern hemisphere, and vice versa). While examples are described in which a single data center is associated with each location, it will be appreciated that any number of data centers and/or other hardware resources may be used according to aspects of the present disclosure.

Example paired locations in which one or more data centers may be associated using a set of candidate data centers include the west coast of the U.S. and eastern Europe, the east coast of the U.S. and India, South Africa and Australia, and/or Brazil and Australia. Such geographic configurations are examples in which the data centers are longitudinally opposed. As another example, a service may be hosted in the northern hemisphere (e.g., using data centers associated with the west coast of the U.S. and eastern Europe) for six months (e.g., during summer in the northern hemisphere), followed by the southern hemisphere (e.g., Brazil and Australia) for the following six months (e.g., during summer in the southern hemisphere). Such geographic configurations are examples in which the data centers are latitudinally opposed. In examples, an association indicated by a set of candidate data centers may also be used in a failover scenario, such that workloads may be processed by another data center of the set of candidate data centers in instances where a data center of the set of candidate data centers has experienced a failure.

While example location criteria are provided, it will be appreciated that any of a variety of other criteria may be used. For example, rather than having a first and second location that are substantially opposite each other (e.g., separated by approximately 180° in longitude and/or approximately 90° in latitude), three, four, or more locations may be used that are approximately equally spaced around the planet (e.g., with respect to longitude and/or latitude).

It will also be appreciated that similar techniques may additionally or alternatively be used for any of a variety of other renewable energy sources or with respect to a variety of other sustainability considerations. In some examples, an energy source may exhibit different variability, such that different criteria may be used to identify geographic locations for a set of candidate data centers accordingly. As an example, tidal energy availability may vary twice daily, such that locations having offsetting energy output may be selected accordingly. As another example, locations with opposing climates (e.g., where one location may experience a rainy season while another location experiences a drought) may be selected in instances where hydroelectric power is used. Additionally, criteria associated with data center cooling may be evaluated, such that a first location having periodically reduced cooling requirements (e.g., resulting from a cooler ambient temperature) may be used to offset periodically increased cooling requirements of a second location and vice versa.

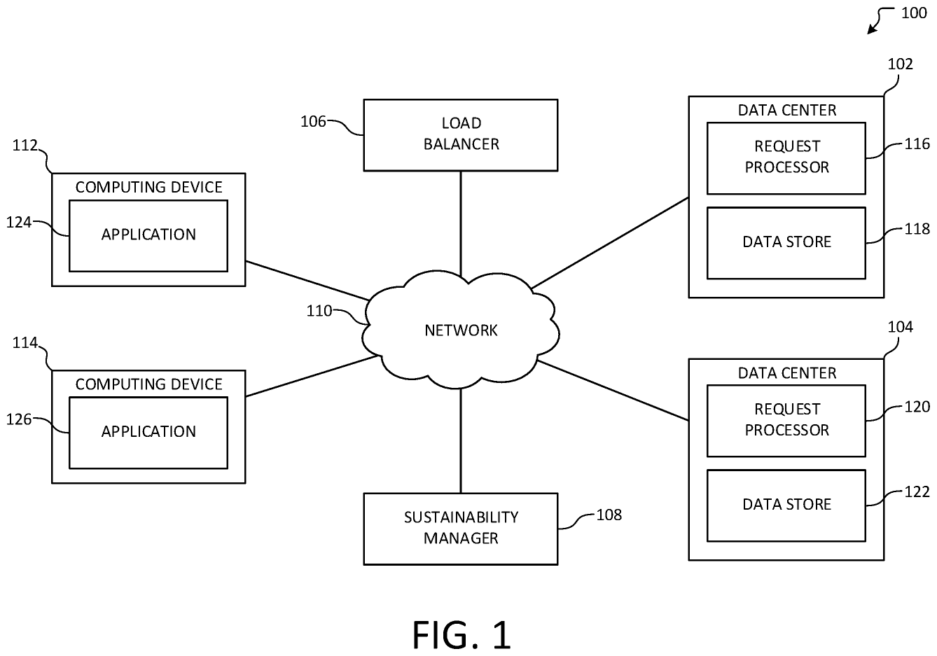

FIG. 1 illustrates an overview of an example system 100 for sustainability-aware data center workload management according to aspects described herein. As illustrated, system 100 includes data center 102, data center 104, load balancer 106, sustainability manager 108, network 110, computing device 112, and computing device 114. In examples, data center 102, data center 104, load balancer 106, sustainability manager 108, computing device 112, and/or computing device 114 may communicate via network 110, which may comprise a local area network, a wireless network, or the Internet, or any combination thereof, among other examples.

Data center 102 and data center 104 may each be part of a set of candidate data centers with which workloads may be processed (e.g., as may be associated with computing device 112 and/or computing device 114). For example, data center 102 may geographically oppose data center 104 (e.g., separated by 180°±20° longitude and/or 90°±10° latitude, among other examples). As noted above, any of a variety of other geographic configurations may be used in other examples.

With reference to data center 102, data center 102 may be comprised of one or more networking devices, storage devices, and/or sever computing devices, among other hardware resources. As illustrated, data center 102 includes request processor 116 and data store 118. Request processor 116 and/or data store 118 may be used to process a workload that is assigned to data center 102. For example, a request may be received from computing device 112 or computing device 114, which may be processed by request processor 116 accordingly.

Data store 118 may store any of a variety of data, including data associated with a workload being processed by data center 102, data received from computing device 112 and/or computing device 114, and/or data to be provided to computing device 112 and/or computing device 114, among other examples. In examples, request processor 116 maintains session state information, which may be used when processing request and/or may be stored in data store 118.

Aspects of data center 104 are similar to data center 102 and are therefore not necessarily redescribed in detail. For example, aspects of request processor 120 and data store 122 may be similar to those discussed herein with respect to request processor 116 and data store 118.

In examples, load balancer 106 processes requests from computing device 112 and computing device 114 to direct the requests to a data center (e.g., data center 102 or data center 104) accordingly. While system 100 is illustrated as comprising a single load balancer 106, it will be appreciated that any number of load balancers may be used in other examples. For example, a load balancer may have an associated geographical region for which it processes requests. It will be appreciated that similar techniques may be applied to any of a variety of similar devices, such as a traffic manager (e.g., in a local, regional, and/or global context).

Sustainability manager 108 may configure aspects of system 100 according to aspects described herein to improve an environmental impact associated with workload processing by data center 102 and/or data center 104. As an example, sustainability manager 108 may generate a set of candidate data centers that includes data center 102 and data center 104 based on one or more characteristics of each data center (e.g., geographic location, available mixture of energy, and/or a schedule according to which the available mixture of energy is expected to vary and/or has historically varied). Accordingly, sustainability manager 108 may determine which data center of the set of candidate data centers is a preferred data center, such that the preferred data center may be used to process workloads accordingly. For example, the determined preferred data center may be used to process new requests. As another example, existing processing may be transitioned from one or more other data centers of the set of candidate data centers to the preferred data center.

In examples, sustainability manager 108 causes a workload transition from a first data center (e.g., data center 102) to a second data center (e.g., data center 104) by configuring load balancer 106 to direct traffic to the second data center instead of the first data center. As another example, sustainability manager 108 may provide a transition indication to the first data center, thereby causing the first data center to transmit session state information and/or any of a variety of other information to the second data center, such that one or more workloads may be transitioned accordingly.

In some instances, an existing workload may not be transitioned or a new request may still be processed by a data center that has reduced latency as compared to the preferred data center, as may be the case when the workload has a stricter latency requirement (e.g., below a predetermined threshold) or when data associated with the workload is unavailable at the preferred data center, among other examples. For example, a workload may be maintained at the data center based on a user indication and/or based on an indication of a third party associated with the processing (e.g., a software developer or system administrator).

In another example, an intermediate data center may be used, which may have a comparable or increased latency and a reduced environmental impact as compared to the initial data center, while potentially having a higher environmental impact as compared to the preferred data center. For example, the initial data center processing a workload may be located to the west of the intermediate data center, while a computing device associated with the workload is at a geographic location that is between the initial and intermediate data centers. As the available solar energy decreases for the initial data center, the workflow may be transitioned to the intermediate data center, thereby maintaining an improved environmental impact while also accounting for changes in latency resulting from the transition. Thus, it will be appreciated that a user experience associated with a workload may be prioritized over an associated environmental impact in examples.

As another example, a transition between data centers may be gradual, thereby reducing the peak traffic between data centers associated with the transition. In some instances, stored energy may be available (e.g., as may have been stored using energy having a comparatively high mixture of renewable energy), such that the stored energy may be used during the transition period. The transition may be performed such that it is substantially complete prior to depletion of the stored energy.

In examples, computing device 112 and computing device 114 may each be any of a variety of computing devices, including, but not limited to, a mobile computing device, a table computing device, a laptop computing device, or a desktop computing device. Computing device 112 and computing device 114 are illustrated as comprising application 124 and application 126, respectively, which may each be any of a variety of applications used to communicate with data center 102 and/or data center 104, among other examples. For example, application 124 and/or application 126 may be a web browser application or a native application.

Similar to data centers 102 and 104, computing devices 112 and 114 may each have an associated geographic location. For example, computing device 112 may be geographically proximate to data center 102, while computing device 114 may be geographically proximate to data center 104. Thus, in the absence of the disclosed sustainability-aware workload management techniques, requests may be processed largely or solely based on associated latency, such that a request of computing device 112 may be processed by data center 102 and a request of computing device 114 may be processed by data center 104. By contrast, according to aspects of the present disclosure, requests of computing device 112 and computing device 114 may be processed by the same preferred data center, which may be data center 102 or data center 104 (e.g., as may be managed by sustainability manager 108).

It will be appreciated that system 100 is provided as an example and, in other examples, any number of computing devices, load balancers, sustainability managers, and data centers may be used.

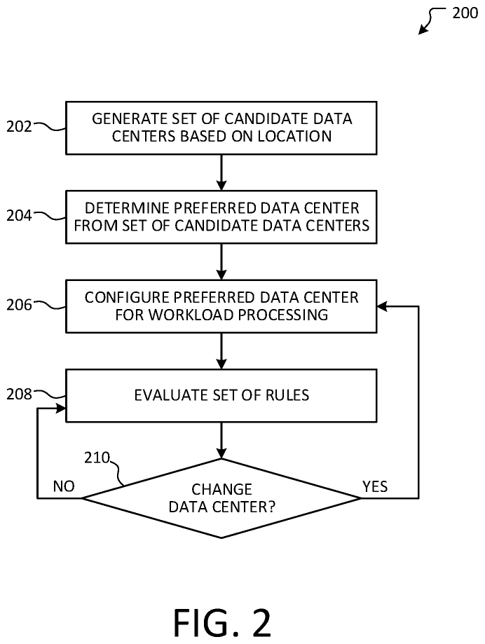

FIG. 2 illustrates an overview of an example method 200 for managing workload processing for a set of candidate data centers according to aspects described herein. In examples, aspects of method 200 are performed by a sustainability manager, such as sustainability manager 108 in FIG. 1.

Method 200 begins at operation 202, where a set of candidate data centers is generated based on a geographic location. For example, operation 202 may determine a geographic location associated with a first data center and may identify one or more other data centers based at least in part of the determined geographic location. As noted above, a data center may be identified that has a difference in latitude and/or longitude by a predetermined amount or within a predetermined range as compared to the first data center. In examples, operation 202 may comprise identifying data centers that are geographically spaced apart by approximately equal distances (e.g., with respect to latitude and/or longitude) around the planet. For example, the set of candidate data centers may be generated such that at least one candidate data center is in a location (and/or uses electricity from a location) that experiences sunlight at any given time. Any of a variety of additional or alternative location criteria may be used at operation 202.

Flow progresses to operation 204, where a preferred data center is determined from the set of candidate data centers. In examples, operation 204 comprises processing a set of rules to identify the preferred data center accordingly. For example, the set of rules may evaluate one or more environmental conditions (e.g., a time of day, a current season, and/or a weather forecast) in view of one or more data center characteristics, thereby identifying a data center having a set of characteristics that most closely matches the current and/or estimated environmental conditions. While examples are described in which a set of rules and associated evaluations are used, it will be appreciated that any of a variety of additional or alternative techniques may be used to identify a preferred data center from a set of candidate data centers based on environmental conditions and data center characteristics.

At operation 206, the determined data center is configured for workload processing. In examples, operation 206 comprises providing an indication to a load balancer (e.g., load balancer 106 discussed above with respect to FIG. 1) to direct subsequent requests to the determined data center (e.g., rather than processing by other data centers of the set of candidate data centers). As another example, operation 206 may comprise providing a transition indication to a data center, such that the recipient data center may transmit state information and/or other information to the preferred data center. The preferred data center may thus begin or resume processing of a workload that was previously assigned to the recipient data center. As noted above, some workloads may not be transferred in some instances.

At operation 208, the set of rules is evaluated. Aspects of operation 208 may be similar to those discussed above with respect to operation 204 and are therefore not necessarily redescribed in detail. For example, the set of rules may be evaluated to make a subsequent determination of a preferred data center (e.g., based on an updated set of environmental conditions). As an example, operation 208 may be performed periodically, such as on an hourly basis or every six or 12 hours, among other examples. As a further example, operation 208 may be performed in response to identifying a change in an environmental condition that may indicate an associated change to a preferred data center, such as a change in the mixture of available energy or a decrease in stored energy availability below a predetermined threshold.

Flow progresses to determination 210, where it is determined whether to change data centers. For example, determination 210 may comprise comparing the previously determined preferred data center (e.g., as may have been determined at operation 204 or at a previous iteration of operation 208) with the data center that was most recently determined at operation 208. If a difference is identified, flow branches “YES” and returns to operation 206, such that workload processing is transitioned from the previously preferred data center to the newly preferred data center. By contrast, if it is determined not to change the data center, flow instead branches “NO” and returns to operation 208, such that the set of rules may be evaluated based on an updated set of environmental conditions. Thus, workload processing by the set of candidate data centers is managed as method 200 loops between operations 206-210 to change preferred data centers in view of dynamic environmental conditions.

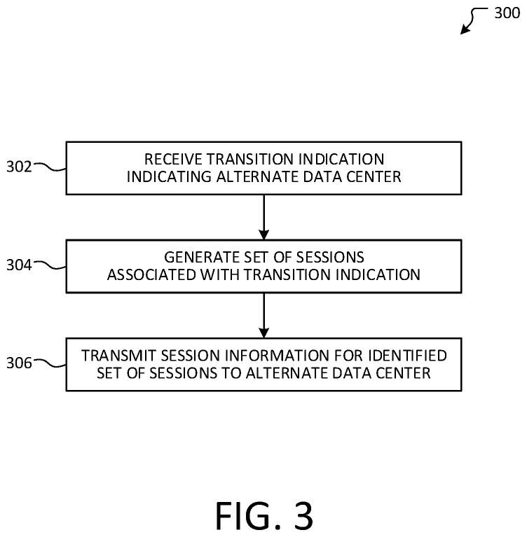

FIG. 3 illustrates an overview of an example method 300 for transitioning a workload from a first data center to a second data center. In examples, aspects of method 300 are performed by a data center, such as data center 102 or data center 104 discussed above with respect to FIG. 1.

Method 300 begins at operation 302, where a transition indication indicating an alternate data center is received. For example, the transition indication may be received from a sustainability manager (e.g., sustainability manger 108 in FIG. 1), which may perform aspects of method 200 discussed above with respect to FIG. 2. For example, the sustainability manager may generate a transition indication according to a predetermined schedule (e.g., on an hourly basis, every six or 12 hours, and/or based on a sunrise/sunset time) and/or in response to identifying a change in an environmental condition (e.g., a change in the mixture of available energy or a decrease in stored energy availability below a predetermined threshold). Thus, the sustainability manager may generate a transition indication as less sunlight is available in a region associated with a currently preferred data center, based on seasonal changes, and/or based on any of a variety of other changes to the available mixture of energy, among other examples.

Accordingly, at operation 304, a set of sessions associated with the transition indication is generated. For example, operation 304 may comprise determining workloads that are currently being processed and/or will be processed by the data center, which are thus being transitioned to the alternate data center as indicated by the transition indication. In some examples, stateful workloads are included in the set of sessions (e.g., having associated session state information), while stateless workloads may be omitted (e.g., as may not have associated session state information). As another example, the generated set of sessions may include a subset of workloads associated with the data center, where workloads having latency requirements below a predetermined threshold may be omitted from the generated set of sessions. It will be appreciated that sessions may be identified for inclusion in the generated set of sessions according to any of a variety of additional or alternative criteria.

Flow progresses to operation 306, where session state information for the generated set of sessions is transmitted to the alternate data center. For example, session information may be accessed from a data store (e.g., data store 118 or data store 122 in FIG. 1) and transmitted to the alternate data center that was indicated by the received transition indication. As another example, the session information may be made available for access by the alternate data center (e.g., from the current data center or from a data store that is remote to both the current data center and the alternate data center, among other examples). Method 300 terminates at operation 306.

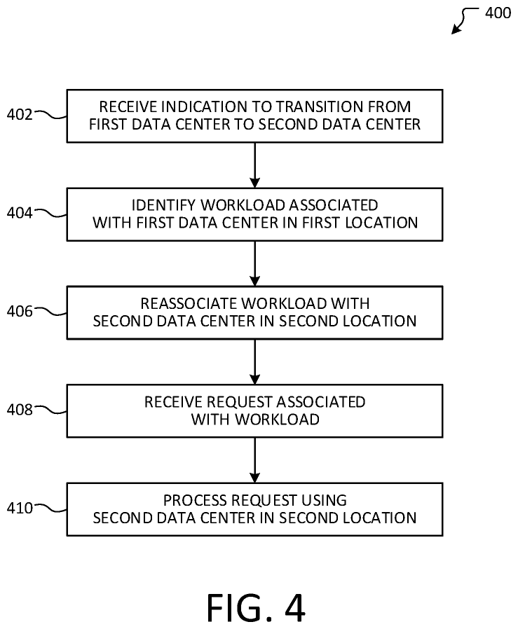

FIG. 4 illustrates an overview of an example method 400 for configuring or reconfiguring a load balancer to transition a workload from a first data center to a second data center. In examples, aspects of method 400 may be performed by a load balancer similar to load balancer 106 discussed above with respect to FIG. 1. For example, a load balancer may be initially configured to direct workloads to a first data center (e.g., as may be currently preferred according to aspects described herein). When it is determined to change preferred data centers (e.g., from the first data center to a second data center), the load balancer may be reconfigured to direct workloads to the second data center accordingly.

Method 400 begins at operation 402, where a transition indication is received. For example, the indication may be received from a sustainability manager (e.g., sustainability manager 108 in FIG. 1), which may be performing aspects similar to those discussed above with respect to method 200 of FIG. 2. The transition indication may include an indication of a first data center from which one or more workloads are to be transitioned and/or an indication of a second, preferred data center to which such workloads and/or future associated requests are to be directed. In other examples, the indication may be based on geographic location, for example indication a transition from a first geographic location to a second geographic location.

At operation 404, a workload associated with a first data center is identified. For example, the workload may be associated with requests from one or more computing devices (e.g., computing devices 112 and/or computing device 114 in FIG. 1). Thus, the load balancer may be configured to direct requests associated with the identified workload to the first data center. It will be appreciated that any number of workloads may be identified at operation 404.

Flow progresses to operation 406, where the workload is reassociated from the first data center to the second data center. As noted above, the first and second data centers may each be associated as part of a set of candidate data centers, such that the first and second data centers are geographically dispersed according to aspects described herein. For example, operation 406 may comprise identifying an association between the workload and the first data center, and updating the association to instead associate the workload with the second data center.

At operation 408, a request associated with the workload that was identified at operation 404 may be received. For example, the request may be received from a computing device. Accordingly, at operation 410, the request may be directed to the second data center for processing as a result of the reassociation that was performed at operation 406. In examples, method 400 may further comprise a determination as to whether the second data center is suitable to process the received request, for example based on a latency threshold of the workload. In instances where it is determined that the second data center is not suitable (e.g., it exhibits a latency above the latency threshold), the request may be provided to the first data center instead. Method 400 terminates at operation 410.

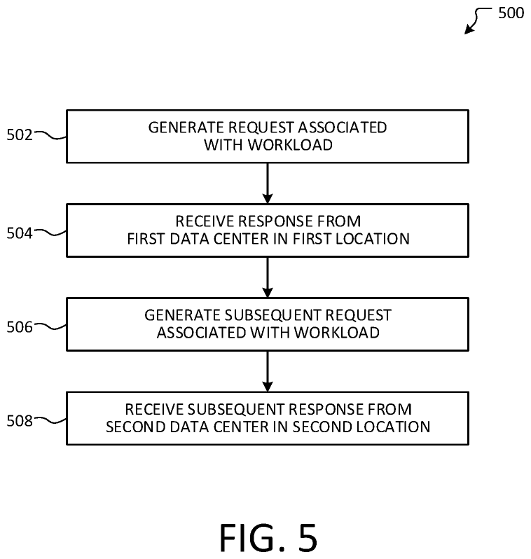

FIG. 5 illustrates an overview of an example method 500 for generating requests by a client device that is associated with a workload that has been transitioned to another data center according to aspects of the present disclosure. In examples, method 500 is performed by a computing device, such as computing device 112 or computing device 114 discussed above with respect to FIG. 1.

Method 500 begins at operation 502, where a request associate with a workload is generated. For example, the request may be generated by an application (e.g., application 124 or application 126 in FIG. 1). The request may be generated as a result of a user activating the application or providing user input to the application, as may result from a user navigating to a website via a web browser. In examples, the generated request is provided to a load balancer, such as load balancer 106 discussed, which may be performing aspects of method 400 discussed above with respect to FIG. 4. It will thus be appreciated that any of a variety of requests may be generated.

Flow progresses to operation 504, where a response is received from a first data center in a first location. For example, the response may be received from a data center (e.g., data center 102 or data center 104) as a result of a load balancer directing the request generated at operation 502 to the load balancer accordingly. The data center may be part of a set of candidate data centers that was generated according to aspects described herein, such that the data center is geographically separate from a second data center.

At operation 506, a subsequent request is generated. Aspects of operation 506 may be similar to those discussed above with respect to operation 502 and are therefore not necessarily redescribed in detail. Foe example, the subsequent request may be generated at a later point in time, such as a time after which a sustainability manager (e.g., sustainability manager 108 in FIG. 1) determined to transition the workload from the first data center to the second data center.

Accordingly, at operation 508, a subsequent response is received from a second data center that is in a second location. Aspects of operation 508 may be similar to those discussed above with respect to operation 504 and are therefore not necessarily redescribed in detail. As noted above, the second data center may be associated with the first data center as part of a set of candidate data centers, such that the second data center is geographically separate from the first data center.

As an example, the first and second data centers may be geographically opposed (e.g., separated by 180°±20° longitude and/or 90°±10° latitude, among other examples). As a further example, the set of candidate data centers may include a third data center, such that the first, second, and third data centers are approximately equally spaced around the planet. It will thus be appreciated that any of a variety of geographic configurations may be used according to aspects of the present disclosure.

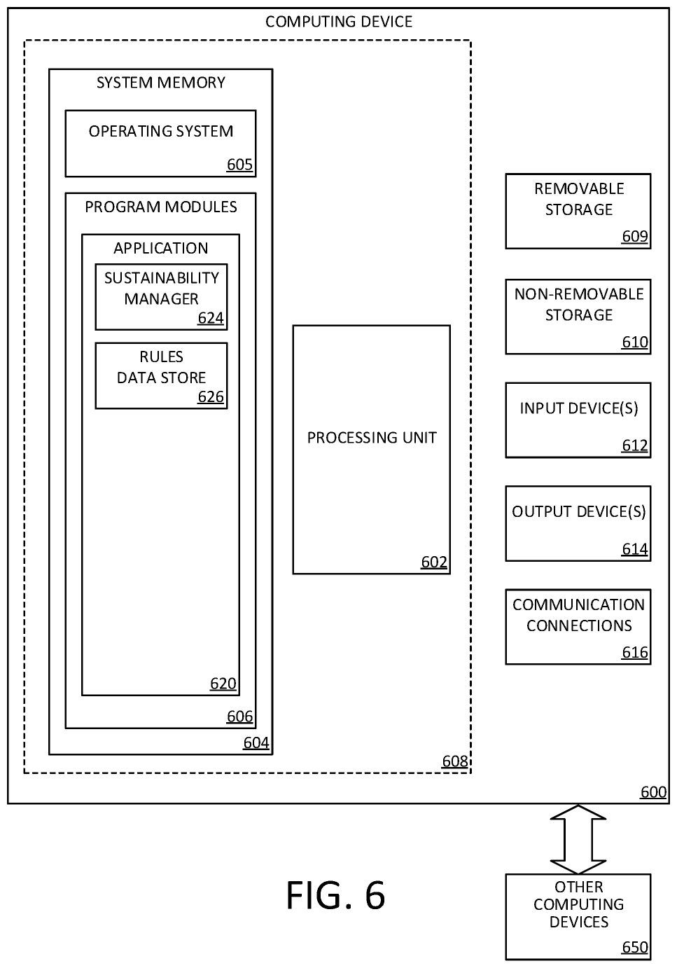

FIGS. 6-8 and the associated descriptions provide a discussion of a variety of operating environments in which aspects of the disclosure may be practiced. However, the devices and systems illustrated and discussed with respect to FIGS. 6-8 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above, including devices 102, 104, 106, 108, 112, and/or 114 in FIG. 1. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may store sustainability manager 624 and rule data store 626 (e.g., as may be used by sustainability manager 624 according to aspects described herein). The operating system 605, for example, may be suitable for controlling the operation of the computing device 600.

Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., application 620) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

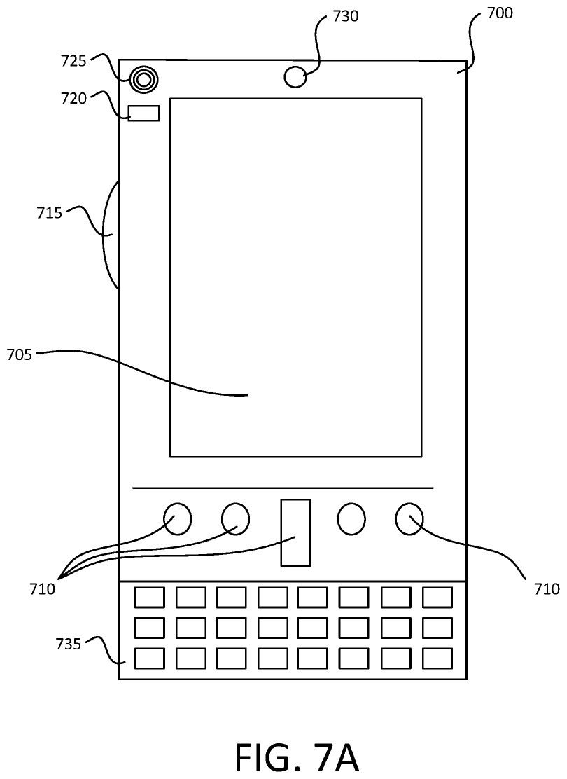

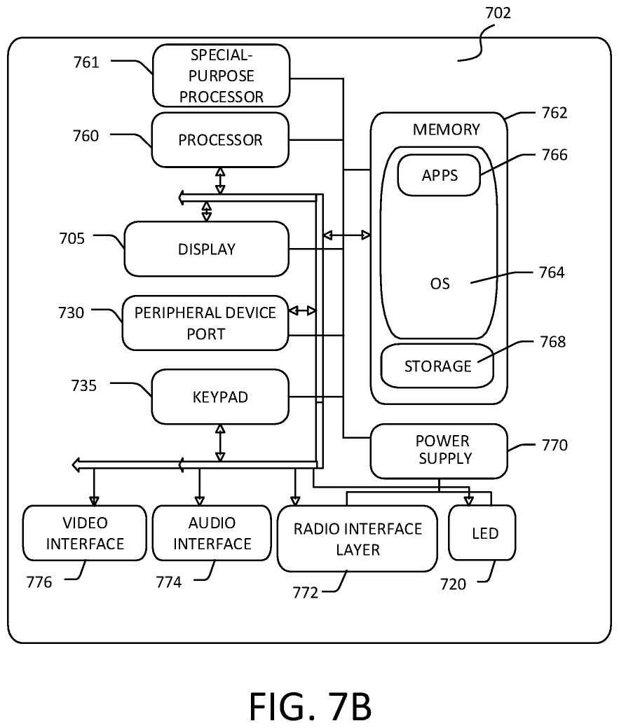

FIGS. 7A and 7B illustrate a mobile computing device 700, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display).

If included, an optional side input element 715 allows further user input. The side input element 715 may be a rotary switch, a button, or any other type of manual input element. In alternative aspects, mobile computing device 700 may incorporate more or less input elements. For example, the display 705 may not be a touch screen in some embodiments.

In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display.

In various embodiments, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one aspect of a mobile computing device. That is, the mobile computing device 700 can incorporate a system (e.g., an architecture) 702 to implement some aspects. In one embodiment, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700 according to aspects described herein.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

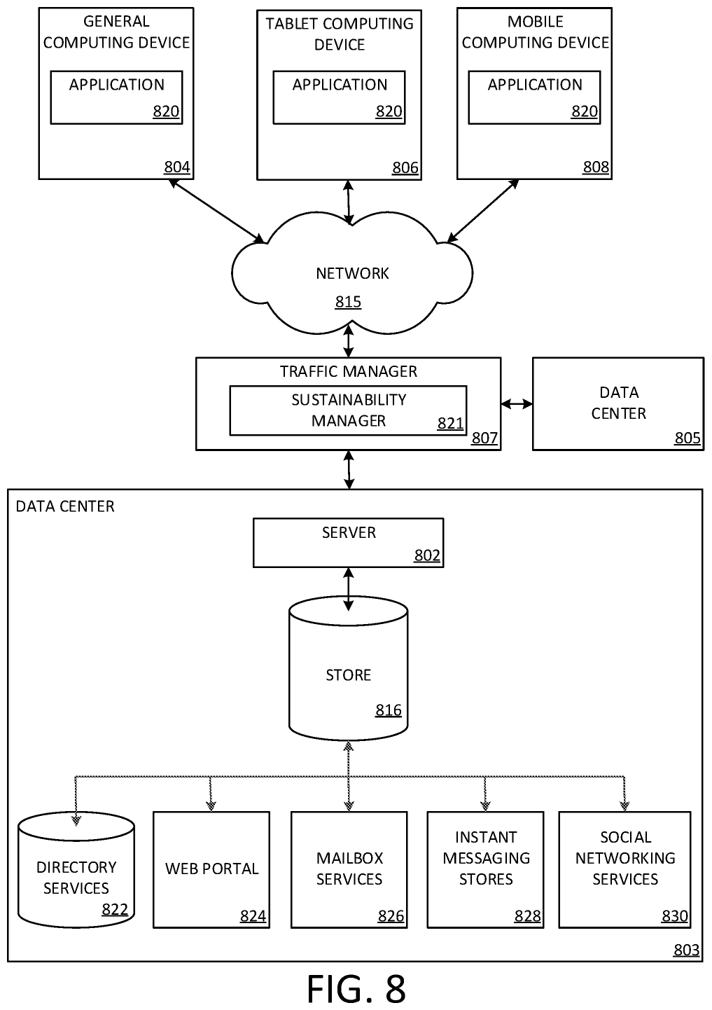

FIG. 8 illustrates one aspect of the architecture of a system for processing data received at a computing system from a remote source, such as a personal computer 804, tablet computing device 806, or mobile computing device 808, as described above. Content displayed at server device 802 of data center 803 may be stored in different communication channels or other storage types. For example, various documents may be stored using a directory service 822, a web portal 824, a mailbox service 826, an instant messaging store 828, or a social networking site 830. Aspects of data center 805 (e.g., including a server, a store, and various services and other stores, not pictured) are similar to those described by the present disclosure with respect to data center 803 and are therefore not necessarily redescribed below in detail.

An application 820 may be employed by a client that communicates with data center 803 and/or data center 805 via traffic manager 807 (e.g., as may be similar to load balancer 106 discussed above with respect to FIG. 1). As illustrated, sustainability manager 821 may be employed to facilitate workload processing for a workload associated with a request received from the application 820 according to aspects described herein. As an example, data center 803 may be determined to be a preferred data center (e.g., by sustainability manager 821, such that traffic manager 807 is configured accordingly). In other examples, sustainability manager 821 may be separate and/or remote from traffic manager 807, similar to the example depicted in FIG. 1. As a result, server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these embodiments of the computing devices may obtain content from the store 816, in addition to receiving graphical data useable to be either pre-processed at a graphic-originating system, or post-processed at a receiving computing system.

It will be appreciated that, as another example, a tablet computing device may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, causes the system to perform a set of operations. The set of operations comprises: receiving a first request associated with a workload assigned to a first data center of a set of candidate data centers, wherein the set of candidate data centers further comprises a second data center geographically opposed to the first data center; providing the first request to the first data center for processing; in response to determining, based on a set of environmental conditions, to transition from the first data center to the second data center, reassigning the workload to the second data center; receiving a second request associated with the workload; and providing the second request to the second data center for processing. In an example, the set of environmental conditions includes a time of day; and the first data center and the second data center are longitudinally opposed to offset variability of solar energy available to each of the first data center and the second data center. In another example, the set of environmental conditions includes a current season; and the first data center and the second data center are latitudinally opposed to offset variability of solar energy available to each of the first data center and the second data center. In a further example, the set of candidate data centers further comprises a third data center that is longitudinally opposed to the first data center. In yet another example, the workload is a first workload and the set of operations further comprises: receiving, after reassigning the first workload to the second data center, a third request associated with a second workload, wherein the second workload has an associated latency requirement; and based on the associated latency requirement, providing the third request to the first data center instead of the second data center. In a further still example, determining to transition from the first data center to the second data center comprises receiving, from a sustainability manager, an indication to transition from the first data center to the second data center. In another example, the first request and the second request are each received from the same computing device.

In another aspect, the technology relates to a method for transitioning workload processing based on a set of candidate data centers. The method comprises: generating the set of candidate data centers based on, for each data center, a geographic location of the data center and an associated availability of renewable energy, wherein the generated set of candidate data centers includes a first data center that is geographically dispersed from a second data center of the set of candidate data centers; determining, based on a set of environmental conditions, a first preferred data center from the set of candidate data centers; configuring the first preferred data center to process a workload; determining, based on an updated set of environmental conditions, a second preferred data center from the set of candidate data centers that is different from the first preferred data center; and configuring the second preferred data center to process the workload instead of the first preferred data center. In an example, configuring the second preferred data center to process the workload comprises at least one of: providing, to a load balancer, an indication to transition from the first preferred data center to the second preferred data center; or providing, to the first preferred data center, an indication to transition workload processing to the second preferred data center, thereby causing the second preferred data center to receive session state information of the first preferred data center. In another example, the set of environmental conditions and the updated set of environmental conditions each include a time of day; and the first data center and the second data center are longitudinally opposed to offset variability of renewable energy available to each of the first data center and the second data center. In a further example, the set of environmental conditions and the updated set of environmental conditions each include a current season; and the first data center and the second data center are latitudinally opposed to offset variability of renewable energy available to each of the first data center and the second data center. In yet another example, the set of candidate data centers further comprises a third data center that is longitudinally opposed to the first data center. In a further still example, the first data center in the first preferred data center and the second data center is the second preferred data center in a first instance; and the first data center in the first preferred data center and the third data center is the second preferred data center in a second instance.

In a further aspect, the technology relates to a method for managing workload processing by a set of candidate data centers. The method comprises: receiving a first request associated with a workload assigned to a first data center of the set of candidate data centers, wherein the set of candidate data centers further comprises a second data center geographically opposed to the first data center; providing the first request to the first data center for processing; in response to determining, based on a set of environmental conditions, to transition from the first data center to the second data center, reassigning the workload to the second data center; receiving a second request associated with the workload; and providing the second request to the second data center for processing. In an example, the set of environmental conditions includes a time of day; and the first data center and the second data center are longitudinally opposed to offset variability of solar energy available to each of the first data center and the second data center. In another example, the set of environmental conditions includes a current season; and the first data center and the second data center are latitudinally opposed to offset variability of solar energy available to each of the first data center and the second data center. In a further example, the set of candidate data centers further comprises a third data center that is longitudinally opposed to the first data center. In yet another example, the workload is a first workload and the method further comprises: receiving, after reassigning the first workload to the second data center, a third request associated with a second workload, wherein the second workload has an associated latency requirement; and based on the associated latency requirement, providing the third request to the first data center instead of the second data center. In a further still example, determining to transition from the first data center to the second data center comprises receiving, from a sustainability manager, an indication to transition from the first data center to the second data center. In another example, the first request and the second request are each received from the same computing device.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
receiving a first request associated with a workload assigned to a first data center of a set of candidate data centers, wherein the set of candidate data centers further comprises a second data center geographically opposed to the first data center;
providing the first request to the first data center for processing;
in response to determining, based on a set of environmental conditions, to transition from the first data center to the second data center, reassigning the workload to the second data center;
receiving a second request associated with the workload; and
providing the second request to the second data center for processing.

2. The system of claim 1, wherein:
the set of environmental conditions includes a time of day; and
the first data center and the second data center are longitudinally opposed to offset variability of solar energy available to each of the first data center and the second data center.

3. The system of claim 1, wherein:
the set of environmental conditions includes a current season; and
the first data center and the second data center are latitudinally opposed to offset variability of solar energy available to each of the first data center and the second data center.

4. The system of claim 3, wherein the set of candidate data centers further comprises a third data center that is longitudinally opposed to the first data center.

5. The system of claim 1, wherein the workload is a first workload and the set of operations further comprises:
receiving, after reassigning the first workload to the second data center, a third request associated with a second workload, wherein the second workload has an associated latency requirement; and
based on the associated latency requirement, providing the third request to the first data center instead of the second data center.

6. The system of claim 1, wherein determining to transition from the first data center to the second data center comprises receiving, from a sustainability manager, an indication to transition from the first data center to the second data center.

7. The system of claim 1, wherein the first request and the second request are each received from the same computing device.

8. A method for transitioning workload processing based on a set of candidate data centers, the method comprising:
generating the set of candidate data centers based on, for each data center, a geographic location of the data center and an associated availability of renewable energy, wherein the generated set of candidate data centers includes a first data center that is geographically dispersed from a second data center of the set of candidate data centers;
determining, based on a set of environmental conditions, a first preferred data center from the set of candidate data centers;
configuring the first preferred data center to process a workload;
determining, based on an updated set of environmental conditions, a second preferred data center from the set of candidate data centers that is different from the first preferred data center; and
configuring the second preferred data center to process the workload instead of the first preferred data center.

9. The method of claim 8, wherein configuring the second preferred data center to process the workload comprises at least one of:
providing, to a load balancer, an indication to transition from the first preferred data center to the second preferred data center; or
providing, to the first preferred data center, an indication to transition workload processing to the second preferred data center, thereby causing the second preferred data center to receive session state information of the first preferred data center.

10. The method of claim 8, wherein:
the set of environmental conditions and the updated set of environmental conditions each include a time of day; and
the first data center and the second data center are longitudinally opposed to offset variability of renewable energy available to each of the first data center and the second data center.

11. The method of claim 8, wherein:
the set of environmental conditions and the updated set of environmental conditions each include a current season; and
the first data center and the second data center are latitudinally opposed to offset variability of renewable energy available to each of the first data center and the second data center.

12. The method of claim 11, wherein the set of candidate data centers further comprises a third data center that is longitudinally opposed to the first data center.

13. The method of claim 12, wherein:
the first data center in the first preferred data center and the second data center is the second preferred data center in a first instance; and
the first data center in the first preferred data center and the third data center is the second preferred data center in a second instance.

14. A method for managing workload processing by a set of candidate data centers, the method comprising:
receiving a first request associated with a workload assigned to a first data center of the set of candidate data centers, wherein the set of candidate data centers further comprises a second data center geographically opposed to the first data center;
providing the first request to the first data center for processing;
in response to determining, based on a set of environmental conditions, to transition from the first data center to the second data center, reassigning the workload to the second data center;
receiving a second request associated with the workload; and
providing the second request to the second data center for processing.

15. The method of claim 14, wherein:
the set of environmental conditions includes a time of day; and
the first data center and the second data center are longitudinally opposed to offset variability of solar energy available to each of the first data center and the second data center.

16. The method of claim 14, wherein:
the set of environmental conditions includes a current season; and
the first data center and the second data center are latitudinally opposed to offset variability of solar energy available to each of the first data center and the second data center.

17. The method of claim 16, wherein the set of candidate data centers further comprises a third data center that is longitudinally opposed to the first data center.

18. The method of claim 14, wherein the workload is a first workload and the method further comprises:
receiving, after reassigning the first workload to the second data center, a third request associated with a second workload, wherein the second workload has an associated latency requirement; and
based on the associated latency requirement, providing the third request to the first data center instead of the second data center.

19. The method of claim 14, wherein determining to transition from the first data center to the second data center comprises receiving, from a sustainability manager, an indication to transition from the first data center to the second data center.

20. The method of claim 14, wherein the first request and the second request are each received from the same computing device.
